(19) United States
(12) Patent Application Publication
(10) Pub. No.: US 2025/0137861 A1
(43) Pub. Date: May 1, 2025

(54) METHOD FOR ASCERTAINING AN ACTUATION OF A DOOR OR A WINDOW IN ONE OR MORE ROOMS

(71) Applicant: Robert Bosch GmbH, Stuttgart (DE)

(72) Inventors: Sara Soltani, Limhamn (SE); Thomas Block, Reutlingen (DE); Kaustubh Gandhi, Filderstadt (DE); Shubhabrata Paul, Hjärup (SE)

(21) Appl. No.: 18/693,591

(22) PCT Filed: Apr. 19, 2023
(86) PCT No.: PCT/EP2023/060144

§ 371 Date: Mar. 20, 2024

(30) Foreign Application Priority Data
Apr. 25, 2022 (DE) 10 2022 203 982.3

(51) Int. Cl. G01L 23/08

(52) U.S. Cl. CPC G01L 23/08

(57) ABSTRACT

A method for ascertaining an actuation of a door or a window in one or more rooms using a pressure sensor disposed in one of the rooms. The method includes: detecting pressure values using the pressure sensor; determining the sum of the absolute first order rates of change and the sum of the absolute second order rates of change of the most recent pressure values at the multiple points in time; determining the global maximum and minimum values of the sums within a time window; identifying a local extremum of the sums of the absolute first order rates of change and/or the sums of the absolute second order rates of change based on the global maximum and minimum values of the sums within the time window; ascertaining an actuation of the door and/or the window based on a comparison of the ascertained local extremum with a threshold value.

### FIELD

The present invention relates to a method for ascertaining an actuation of a door or a window in one or more rooms by means of a pressure sensor which is disposed in one of the rooms.

The present invention also relates to an ascertainment apparatus which is configured to ascertain an actuation of a door or a window in one or more rooms by means of a pressure sensor which is disposed in one of the rooms.

### BACKGROUND INFORMATION

As is understood, opening or closing windows and doors in a room can cause sudden pressure changes. These pressure changes can be measured using pressure sensors.

However, due to natural pressure fluctuations, interference effects and signal drift, ascertaining an actuation of a window or a door based on a pressure sensor signal is difficult, in particular if there is only one pressure sensor to monitor the actuation of multiple windows and/or doors.

### SUMMARY

In one example embodiment, the present invention provides a method for ascertaining an actuation of a door or a window in one or more rooms by means of a pressure sensor which is disposed in one of the rooms, comprising the steps:
detecting pressure values at multiple points in time using the pressure sensor;
determining the sum of the absolute first order rates of change and determining the sum of the absolute second order rates of change of the most recent pressure values at the multiple points in time;
determining the global maximum and minimum values of the sums of the rates of change within a time window;
identifying a local extremum of the sums of the absolute first order rates of change and/or the sums of the absolute second order rates of change on the basis of the global maximum and minimum values of the sums within the time window;
ascertaining an actuation of the door and/or the window based on a comparison of the ascertained local extremum with a threshold value.

In one example embodiment, the present invention provides an ascertainment apparatus, which is configured to ascertain an actuation of a door or a window in one or more rooms by means of a pressure sensor which is disposed in one of the rooms, comprising:
a detection device configured to detect pressure values at multiple points in time using the pressure sensor;
a first determination device configured to determine the sum of the first order absolute rates of change and/or determine the sum of the absolute second order rates of change of the most recent pressure values at the multiple points in time;
a second determination device configured to determine the global maximum and minimum values of the sums of the rates of change within a time window;
an identification device configured to identify a local extremum of the sums of the absolute first order rates of change and the sums of the absolute second order rates of change on the basis of the global maximum and minimum values of the sums within the time window;
an ascertainment device configured to ascertain an actuation event of the door and/or the window based on a comparison of the ascertained local extremum with a threshold value.

A door is in particular intended to be understood to be doors between two interior spaces of a building, between an interior space and a hallway of the building and/or between an interior space and a surroundings outside the building.

The method according to the present invention can in particular be used to monitor multiple windows and/or doors, in particular to determine whether at least one of the windows and/or the doors is being actuated.

One of the advantages achieved with this is that actuation of a window or a door in one or more rooms can be reliably ascertained. Another advantage is that actuation of multiple windows and/or doors can be ascertained with just one pressure sensor. The pressure sensor can also be disposed at a distance from the window or door, in particular not in direct proximity to the window or door. The influence of sensor drift and background noise on the signal quality of the pressure sensor can moreover be reduced. The actuation of a window or door can furthermore be ascertained with little expenditure of energy.

The term “ascertaining an actuation of the door and/or the window” is defined as detecting an actuation event of the door and/or the window, in particular that the door and/or the window is moved from a closed to an open state or vice versa. Ascertaining furthermore also includes classifying the actuation event, in particular whether the window and/or the door is being opened or closed.

The first order rate of change is defined as the mathematical rate of change of a function through a series of values, in particular a derivative of the function through the series of values. The second order rate of change is defined as the mathematical rate of change of the rate of change a function through the series of values, in particular a second derivative of the function through the series of values.

A time window is defined as a period of time comprising a number of points in time; the time window in particular includes a number of the most recent points in time at which a pressure value is measured. The time window can be 2-5 seconds, for instance.

Further features, advantages and other embodiments of the present invention are described in the following or are thereby disclosed.

According to an advantageous further development of the present invention, the detected pressure values are filtered by an edge-preserving filter, in particular a bilateral filter. Alternatively or additionally, a total variation filter can be used. An edge-preserving filter can be used to filter background noise out of the pressure signal values. The advantage of this is that the actuation of a window or door can be reliably ascertained from the pressure signal values. The use of an edge-preserving filter in particular makes it possible to easily and reliably detect changes in the pressure signal values.

According to an advantageous further development of the present invention, detecting an actuation is suspended for a period of 5 seconds, preferably 3 seconds, when an actuation is ascertained. After ascertaining an actuation, the pressure signal values can exhibit high variance, so that multiple false actuations could be ascertained even though only one actuation of a window or door has taken place. By suspending the method for a period of time, these erroneous ascertainments can easily be reduced.

According to an advantageous further development of the present invention, ascertaining an actuation is based on additional statistical parameters, in particular a standard deviation of the detected pressure values, on a number of mean value exceedances, and/or on a ratio of a maximum and minimum pressure value. The advantage of this is that the actuation of a window or door can be ascertained even more reliably. The aforementioned additional statistical parameters enable verification of the ascertained actuations and/or a more precise classification of the ascertained actuation. The additional statistical parameters can be analyzed in the same way as the sum of the absolute rates of change with respect to the maximum and minimum values within a time window. The maximum and minimum value can in particular be used for the threshold value calculation of the statistical parameters.

According to an advantageous further development of the present invention, a topology of one or more rooms is taken into account for ascertaining an actuation. The topology of a room in particular includes the floor plan, the height, position and inclination of walls within the room, the arrangement, i.e. the position and orientation, of the windows and doors and the placement of the pressure sensor in the room. The topology in particular also includes the closing direction of the windows and doors-opening inward or outward. This makes it easier to ascertain whether a window or door is being actuated, and in particular whether the window or the door is being closed or opened.

According to an advantageous further development of the present invention, the threshold value is defined based on historical data and/or machine learning. The threshold value is used to distinguish whether a local extremum of the pressure values means that a window or door is being actuated, or is merely being caused by ambient noise. If the threshold value is too high, individual actuations cannot be detected, in particular if the actuated window or the actuated door is far away from the pressure sensor. A low threshold value, on the other hand, increases the number of false positive ascertainments of actuations. Defining the threshold value based on historical data and/or machine learning, makes it possible to reduce the likelihood of wrongly ascertained or undetected actuations. In particular, data sets of different scenarios can be used to define the threshold value, for example different opening and closing processes, different distances between a window and the pressure sensor, additional ventilation with fans, etc. If multiple statistical parameters are used to ascertain an actuation of a window or a door, a threshold value can be set for each of the statistical parameters, in particular using historical data and/or machine learning.

According to an advantageous further development of the present invention, between 1 and 100, in particular between 10 and 50, and preferably between 20 and 30 pressure values are measured per second. This makes it possible to reliably ascertain actuations of windows or doors and at the same time reduce the energy consumption for the method.

According to an advantageous further development of the present invention ascertaining the actuation includes determining the distance between the pressure sensor and the window or the door, determining a speed of the window or the door and/or determining a closing direction of the window or the door. The analyzed pressure signals can be used to obtain additional information about the actuation of the window or door, in particular taking into account the topology of the room. In particular information such as the distance between the pressure sensor and an opened window can be ascertained by comparing a pressure signal with historical or learned known pressure signals.

Further important features and advantages of the present invention will emerge from the disclosure herein.

It goes without saying that the aforementioned features and the features yet to be explained in the following can be used not only in the respectively specified combination, but also in other combinations or on their own, without leaving the scope of the present invention.

Preferred designs and embodiments of the present invention are shown in the figures and explained in more detail in the following description.

### DETAILED DESCRIPTION OF EXAMPLE EMBODIMENTS

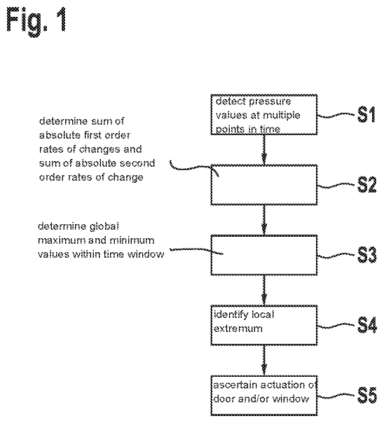

FIG. 1 schematically, steps of a method according to an example embodiment of the present invention.

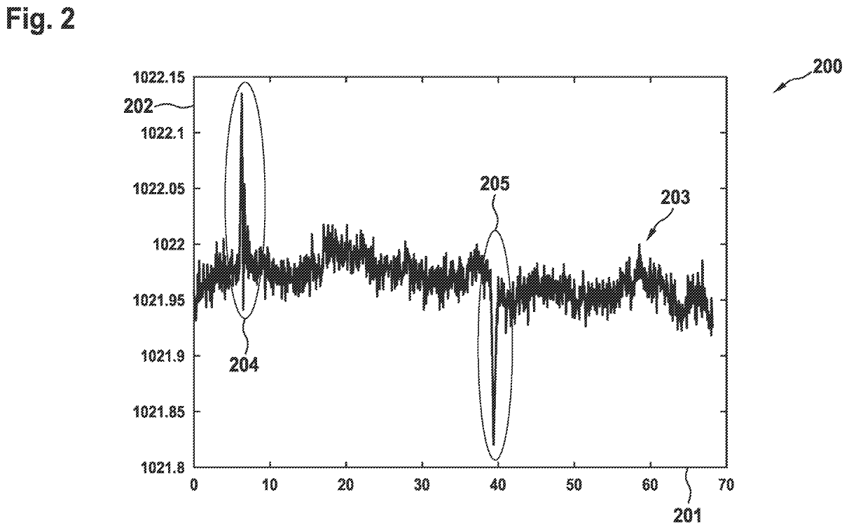

FIG. 2 schematically, a graph of a progression of pressure values according to an example embodiment of the present invention.

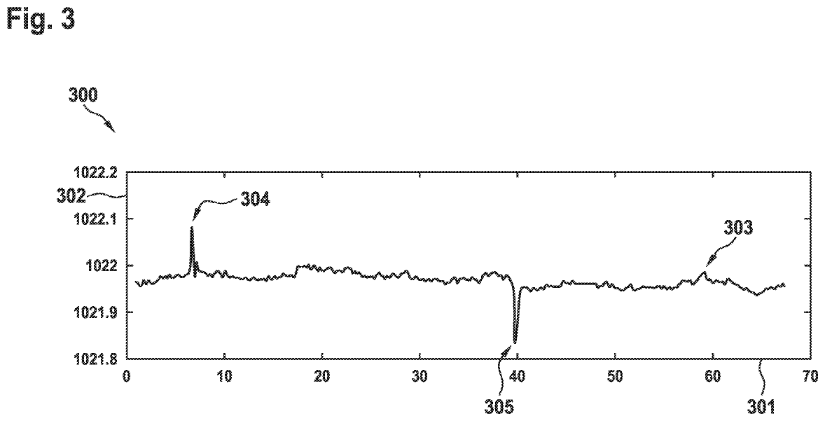

FIG. 3 schematically, a graph of a progression of filtered pressure values according to an example embodiment of the present invention.

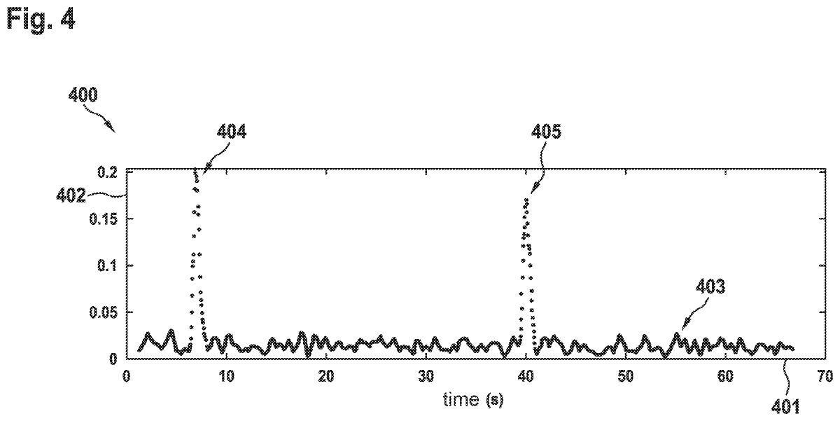

FIG. 4 schematically, a graph of a progression of a sum of absolute rates of change of pressure values according to an example embodiment of the present invention.

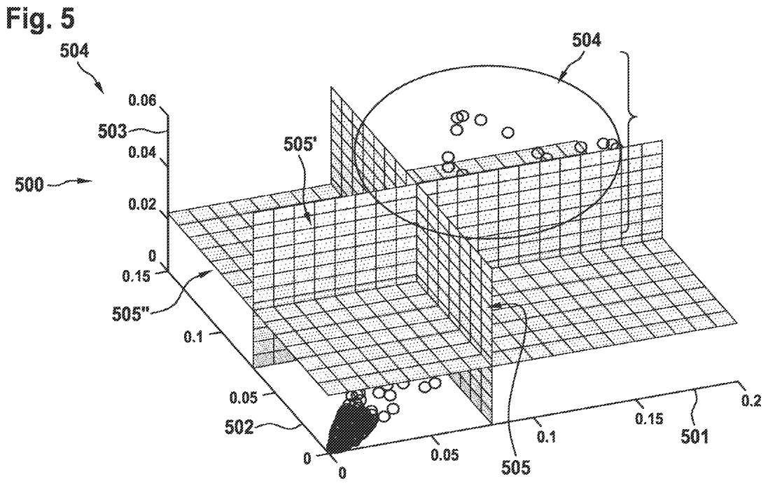

FIG. 5 schematically, a graph with threshold value comparisons according to an example embodiment of the present invention.

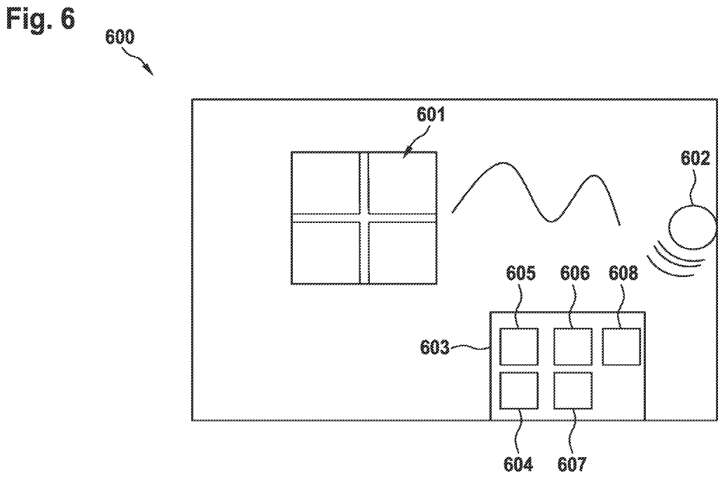

FIG. 6 schematically, a room comprising an ascertainment apparatus according to an example embodiment of the present invention.

### DETAILED DESCRIPTION OF EXAMPLE EMBODIMENTS

FIG. 1 schematically shows steps of a method according to an embodiment of the present invention.

FIG. 1 shows of a method for ascertaining an actuation of a door or a window in one or more rooms by means of a pressure sensor which is disposed in one of the rooms.

In a step S1, the pressure sensor is used to detect pressure values at multiple points in time. The pressure sensor can have a sampling rate of 25 hertz, for example. The pressure sensor acquires the pressure at multiple points in time, so that an actuation of the window or the door can be deduced from the progression. The pressure values can be smoothed with an edge-preserving filter to remove ambient noise.

In a step S2, the sum of the absolute first order rates of change and the sum of the absolute second order rates of change of the most recent pressure values at the multiple points in time are determined. First, the first order rate of change, in particular a value of a first derivative, and the second order rate of change, in particular a value of a second derivative, are determined from the progression of the pressure values at the multiple points in time. Then the sum of the magnitudes of the most recent first order rates of change is determined. This means in particular that the magnitudes of the rates of change of the last 50-300, preferably 100-200, measured pressure values are summed. The sum of the magnitudes of the most recent second order rates of change is determined in the same way. This results in a progression of the sum of the magnitudes of the first and second order rates of change over the multiple points in time.

In a step S3, the global maximum and minimum values of the sums of the rates of change within a time window are determined. The global maximum and minimum are used to determine the limits of rates of change within the time window. This can reduce the impact of ambient pressure fluctuations or sensor drift, for instance, because any existing “fundamental change” in pressure can be taken into account in the ascertainment of actuations of the door or the window. In particular, the level of a detected extremum can be compared with the “fundamental change” of the pressure in order to be able to ascertain relevant possible actuations of the window or the door. The global maximum and minimum values of other statistical parameters, for example the standard deviation or the peak-to-valley ratio, can be included in the same way as well.

In a step S4, a local extremum of the sums of the absolute first order rates of change and/or the sums of the absolute second order rates of change is identified on the basis of the global maximum and minimum values of the sums within the time window. Possible actuations of the window or door can in particular be ascertained on the basis of local maximums of the first order rates of change. Local extremums that are a small distance from the minimum value of the sum and a large distance from the maximum value of the sum (i.e. that are low compared to the values in a time window) cannot be taken into account, because they are unlikely to be caused by an actuation of the window or the door.

In a step S5, an actuation of the door and/or the window is ascertained based on a comparison of the ascertained local extremum with a threshold value. The ascertained local extremums suggest a possible actuation, but could also be a false-positive result. Comparison with a threshold value reduces the false-positive results. If the value of the local extremum is in particular greater than the threshold value, an actuation of the window or the door may have occurred. The ascertainment can also include a classification of the actuation. For example, the sum of the absolute second rates of change and/or the corresponding pressure values can be used to determine whether the window or door is being opened or closed. In addition to the sums of the rates of change, it is possible to compare other statistical parameters derived from the pressure values with a threshold value in order to improve the reliability of the method.

FIG. 2 schematically shows a graph of a progression of pressure values according to an embodiment of the present invention.

FIG. 2 shows a graph 200 of a progression of pressure values 203. Such a progression can result from the detected pressure values in accordance with step S1 of FIG. 1, for example. The time is shown in seconds on the x-axis 201 and the pressure is shown in hectopascals on the y-axis 202. There are two spikes 204, 205 that could suggest an actuation event. First a local maximum 204 can be seen, and later a local minimum 205. This could suggest an opening followed by a closing of a door or a window, for example.

FIG. 3 schematically shows a graph of a progression of filtered pressure values according to an embodiment of the present invention.

FIG. 3 shows a graph 300 of a progression of filtered pressure values 303. The progression can be obtained by smoothing the progression of the pressure values 203 according to FIG. 2 using an edge-preserving filter, for example. The x-axis shows th time in seconds and the y-axis shows the pressure in hectopascals. Two spikes 304, 305 that could suggest an actuation event can be seen.

FIG. 4 schematically shows a graph of a progression of a sum of absolute rates of change of pressure values according to an embodiment of the present invention.

FIG. 4 shows a graph 400 of a progression of a sum of absolute rates of change of pressure values 403. Such a progression can be calculated from the sum of the absolute first order rates of change in accordance with step S2 of FIG. 1, for example. The time seconds is shown on the x-axis and the dimensionless absolute summed rates of change are shown on the y-axis. Two spikes 404, 405 that suggest a possible actuation can be seen. The sum of the first order rate of change of the pressure values can be lower using a filtered pressure progression according to FIG. 3 than for unfiltered pressure progressions, and the extreme values can be more clearly visible.

FIG. 5 schematically shows a graph with threshold value comparisons according to an embodiment of the present invention.

FIG. 5 shows a graph 500 comparing statistical parameters with threshold values. Such a graph can be obtained from the comparison of the ascertained local extremums with a threshold value in accordance with step S5 of FIG. 1, for example. The dimensionless sum of the absolute first order rates of change of the pressure values is shown on the x-axis 501, the dimensionless peak-to-valley ratio of the pressure values is shown on the y-axis 502 and the standard deviation of the pressure values is shown on the Z-axis 503. The threshold values for the sum of the absolute first order rates of change 505, for the peak-to-valley ratio 501′ and for the standard deviation 505″ are shown as planes in the graph 500. Some of the identified local extremums 504 lie above all three threshold values. These local extremums 504 therefore correspond to actuations of a window or a door.

To classify a local extremum as an actuation, it can be required that all of the used statistical parameters are above corresponding threshold values or that at least a subset of the statistical parameters are above the corresponding threshold values. The threshold values can be defined based on historical data and/or machine learning, for instance. It is also possible that a threshold value of one statistical parameter is dependent on other statistical parameters. In this case, the planes 505, 505′ and 505″ would not be perpendicular to the axes but would be tilted or curved.

The number and type of statistical parameters used to ascertain the actuation of the window or door can differ from the statistical parameters according to FIG. 5. For example, one to five statistical parameters can be used to ascertain actuations. In addition to the statistical parameters shown in FIG. 5, possible statistical parameters are the sum of the absolute second order rates of change or the number of exceedances of the mean value.

FIG. 6 schematically shows a room comprising an ascertainment apparatus according to an embodiment of the present invention.

FIG. 6 shows a room 600 with a window 601, a pressure sensor 602 and an ascertainment apparatus 603. The ascertainment apparatus 603 is configured to ascertain an actuation of the window 601 in the room 600 by means of the pressure sensor 602 which is disposed in the room. The ascertainment apparatus 603 comprises a detection device 604, which is configured to detect pressure values using the pressure sensor 602 at multiple points in time in accordance with step S1 according to FIG. 1. The ascertainment apparatus 603 further comprises a determination device 605, which is configured to determine the sum of the absolute first order rates of change and determine the sum of the absolute second order rates of change of the most recent pressure values at the multiple points in time in accordance with step S2 according to FIG. 1. The ascertainment apparatus 603 also comprises a second determination device 606, which is configured to determine the global maximum and minimum values of the sums of the rates of change within a time window in accordance with step S3 according to FIG. 1. The ascertainment apparatus 603 moreover comprises an identification device 607, which is configured to identify a local extremum of the sums of the absolute first order rates of change and/or the sums of the absolute second order rates of change on the basis of the global maximum and minimum values of the sums within the time window in accordance with step S4 according to FIG. 1, and an ascertainment device 608, which is configured to ascertain an actuation event of the door and/or the window based on a comparison of the ascertained local extremum with a threshold value in accordance with step S5 according to FIG. 1.

When the window 601 or a door (not depicted) is opened or closed, a pressure fluctuation is created in the room 600 that can be detected by the pressure sensor 602. The pressure sensor 602 provides data about the pressure to the ascertainment apparatus 603, which ascertains whether the pressure fluctuation was caused by an actuation of the window 601. It is possible that the pressure sensor 602 and the ascertainment apparatus 601 form a single unit.

The pressure sensor 602 is in particular disposed at a fixed position in the room 600.

It is also possible for multiple windows 601 or doors to be located in the room 600, or in multiple rooms 600, for which actuation can be ascertained.

In summary, at least one embodiment of the present invention has at least one of the following features and/or provides at least one of the following advantages:
reliably detecting actuations of a door or a window
energy efficient operation
monitoring multiple windows/doors with one pressure sensor

Even though the present invention has been described with reference to preferred embodiment examples, it is not limited to these and can be modified in a variety of ways.

1-9. (canceled)

10. The method for ascertaining an actuation of a door or a window in one or more rooms using a pressure sensor which is disposed in one of the rooms, the method comprising the following steps:
detecting pressure values at multiple points in time using the pressure sensor;
determining a sum of absolute first order rates of change of most recent pressure values at the multiple points in time and determining a sum of the absolute second order rates of change of the most recent pressure values at the multiple points in time;
determining global maximum and minimum values of the sums of the absolute first order and absolute second order rates of change within a time window;
identifying a local extremum of the sums of the absolute first order rates of change and/or the sums of the absolute second order rates of change based on the global maximum and minimum values of the sums within the time window; and
ascertaining an actuation of the door and/or the window based on a comparison of the ascertained local extremum with a threshold value.

11. The method according to claim 10, wherein the detected pressure values are filtered by an edge-preserving filter.

12. The method according to claim 10, wherein the detected pressure values are filtered by a bilateral filter.

13. The method according to claim 10, wherein the detecting is suspended for a period of 5 seconds when an actuation is ascertained.

14. The method according to claim 10, wherein the ascertaining of the actuation is based on: (i) additional statistical parameters including a standard deviation of the detected pressure values, and/or (ii) a number of mean value exceedances, and/or (iii) a ratio of a maximum and minimum pressure value.

15. The method according to claim 10, wherein a topology of one or more of the rooms is taken into account for ascertaining an actuation.

16. The method according to claim 10, wherein the threshold value is defined based on historical data and/or machine learning.

17. The method according to claim 10, wherein between 1 and 100 pressure values are measured per second.

18. The method according to claim 10, wherein the ascertaining of the actuation includes determining a distance between the pressure sensor and the window or the door, and/or determining a speed of the window or the door and/or determining a closing direction of the window or the door.

19. An ascertainment apparatus configured to ascertain an actuation of a door or a window in one or more rooms using a pressure sensor which is disposed in one of the rooms, the ascertainment apparatus comprising:
a detection device configured to detect pressure values at multiple points in time using the pressure sensor;
a first determination device configured to determine a sum of the first order absolute rates of change of most recent pressure values at the multiple points in time and determine the sum of the absolute second order rates of change of the most recent pressure values at the multiple points in time;
a second determination device configured to determine global maximum and minimum values of the sums of the first order absolute and second order absolute rates of change within a time window;
an identification device configured to identify a local extremum of the sums of the absolute first order rates of change and/or the sums of the absolute second order rates of change, based on the global maximum and minimum values of the sums within the time window; and
an ascertainment device configured to ascertain an actuation event of the door and/or the window based on a comparison of the ascertained local extremum with a threshold value.
